(19) United States
(12) Patent Application Publication
(10) Pub. No.: US 2009/0107991 A1
(43) Pub. Date: Apr. 30, 2009

(54) ELECTRIC INDUCTION HEATING AND MELTING OF AN ELECTRICALLY CONDUCTIVE MATERIAL IN A CONTAINEMENT VESSEL

(76) Inventor: John H. Mortimer, Little Egg Harbor Township, NJ (US)

Correspondence Address: PHILIP O. POST;INDEL, INC., PO BOX 157, RANCOCAS, NJ, 08073, US

(21) Appl. No.: 12/260,894

(22) Filed: Oct. 29, 2008

Related U.S. Application Data
(60) Provisional application No. 60/983,358, filed on Oct. 29, 2007.

(51) Int. Cl. H05B 6/36

(52) U.S. Cl. 219/676

(57) ABSTRACT

An electric induction heating and melting system is provided for inducing heat in an electrically conductive material placed in a containment vessel by bringing a moveable one or more induction coils at least partially enclosed in a refractory material in close contact with the surface level of the melt in the vessel while supplying ac power to the one or more induction coils. The moveable one or more induction coils can be kept in close contact with the surface level of the melt as the height of the melt in the vessel changes.

### CROSS-REFERENCE TO RELATED APPLICATIONS

This application claims the benefit of U.S. Provisional Application No. 60/983,358 filed Oct. 29, 2007, hereby incorporated by reference in its entirety.

### FIELD OF THE INVENTION

The present invention generally relates to an electric induction heating system comprising a containment vessel for holding an electrically conductive material and one or more moveable induction coils for heating and melting the electrically conductive material in the containment vessel by bringing the one or more moveable induction coils in close contact with the surface of the electrically conductive material in the containment vessel when alternating current (ac) power is applied to the one or more moveable induction coils.

### BACKGROUND OF THE INVENTION

Flat induction coils are used in electric induction applications. In order to achieve a reasonable electrical efficiency using flat induction coils to heat and melt an electrically conductive load, it is essential to keep the distance between the flat induction coil and the load small and relatively constant.

In melting applications the induction coil must typically be separated from a molten electrically conductive material (melt) by refractory materials, necessarily increasing the distance between the melt and the coil, and thereby decreasing efficiency.

In addition in electric induction heating and melting processes, heating metal parts adjacent to the electrically conductive melt should be avoided. This requires guiding the magnetic flux produced by the induction coil from the backside and circumference of an-induction coil with shunts. This is conventionally achieved using shunts made from laminated steel. Due to the complexity of the shunts they are difficult and expensive to make.

Because of these drawbacks induction heating and melting are not considered viable in some industries. For example the steel industry heats, melts and holds molten steel at a desired temperature by using an electric arc furnace that is typically cylindrical in shape, and has a large diameter so that a shallow depth of material in the furnace is a large amount of molten steel, for example in the range of 200 tonnes.

One objective of the present invention is to heat, melt and hold at a desired temperature, an electrically conductive material, such as a steel alloy composition, with electric induction power without use of an induction furnace having a thick walled refractory.

The above and other aspects of the invention are further set forth in this specification.

### SUMMARY OF THE INVENTION

In one aspect the present invention is apparatus for, and method of, heating and melting an electrically conductive material in a containment vessel by bringing one or more moveable electric induction coils at least partially surrounded by refractory in close contact with the surface of the electrically conductive material in the containment vessel.

These and other examples of the invention are set forth in this specification and the appended claims.

### BRIEF DESCRIPTION OF THE DRAWINGS

For the purpose of illustrating the invention, there is shown in the drawings a form which is presently preferred. It being understood, however, that this invention is not limited to the precise arrangements and instrumentalities shown.

FIG. 1 is a partial cross sectional view of a vessel with a conventional flat inductor utilizing laminated shunts.

FIG. 2 is a top plan view of the vessel shown in FIG. 1 illustrating only the laminated shunts.

FIG. 3 is a cross sectional view of a prior art flat inductor positioned relative to a refractory vessel.

FIG. 4 is a cross sectional view of another prior art flat inductor relative to a refractory vessel.

FIG. 5 is a cross sectional view of one example of the electric induction heating system of the present invention.

FIG. 6 is a cross sectional view of one example of the refractory embedded inductor shown in FIG. 5 through line A-A.

### DETAILED DESCRIPTION OF THE INVENTION

While the invention will be described in connection with a preferred embodiment, it will be understood that it is not intended to limit the invention to that embodiment. On the contrary, it is intended to cover all alternatives, modifications and equivalents as may be included within the scope of the invention.

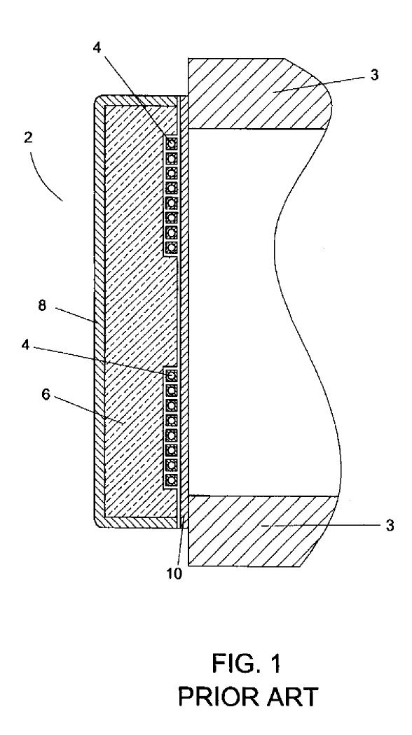

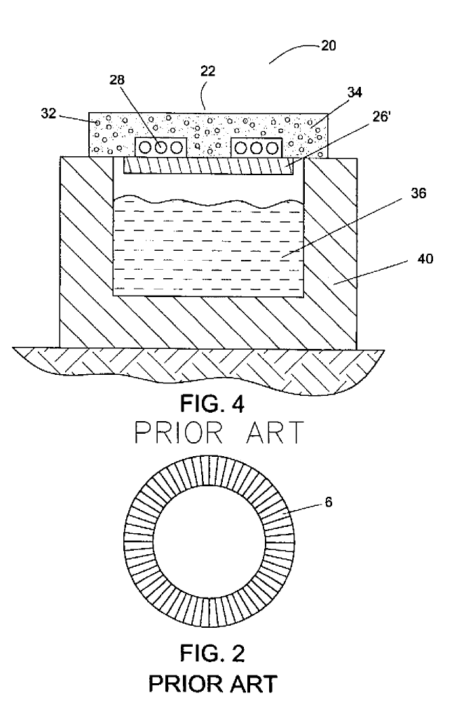

FIG. 1 illustrates a conventional flat inductor assembly 2 that is positioned on the side of a vessel 3 (partially shown). Assembly 2 comprises one or more flat induction coils 4 surrounded by shunts 6. Shunts 6 are typically made of laminated steel or a material providing similar magnetic properties. Shunts 6 surround the coil 4 and direct magnetic flux towards a workpiece (not shown) in vessel 3. Assembly 2 further includes enclosure 8 for containing coil 4 and shunts 6, and thermal insulator 10 for insulating assembly 2 from heat generated in the workpiece. FIG. 2 is an overhead view of the assembly 2 illustrated in FIG. 1 that shows only laminated shunts 6 surrounding the vessel.

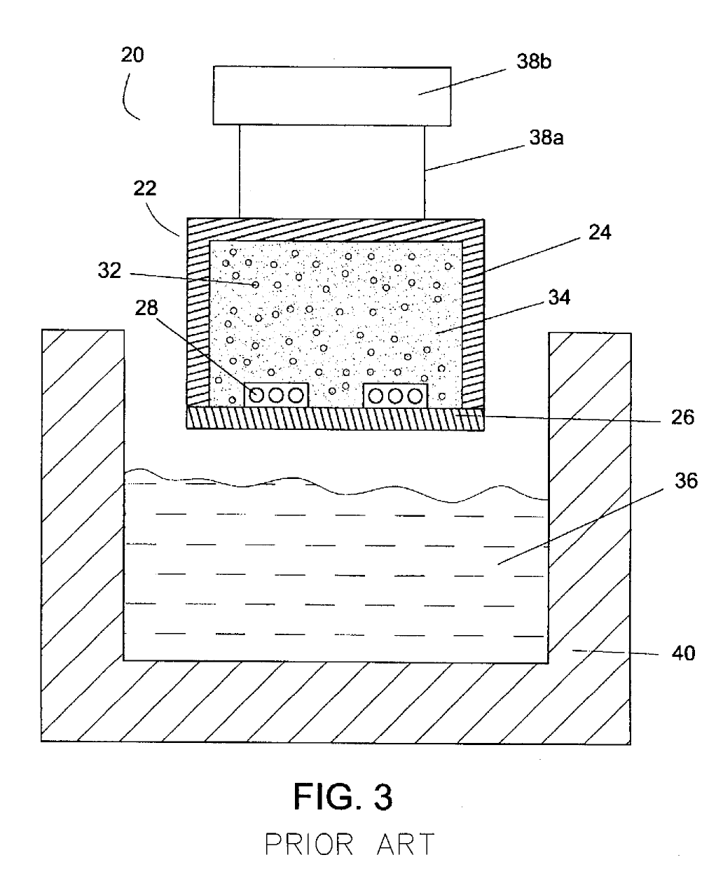

U.S. Pat. No. 6,391,247 provides a system that casts an induction coil in a mixture of a metallic shot, such as iron or steel shot (formed, for example, in the shape of BB spherical projectiles) and a binding media. The coil/aggregate combination is then housed in an enclosure of non-magnetic material, such as aluminum. FIG. 3 and FIG. 4 are flat inductors described in U.S. Pat. No. 6,391,247, with reference numbers used in those figures being the same as those used in U.S. Pat. No. 6,391,247.

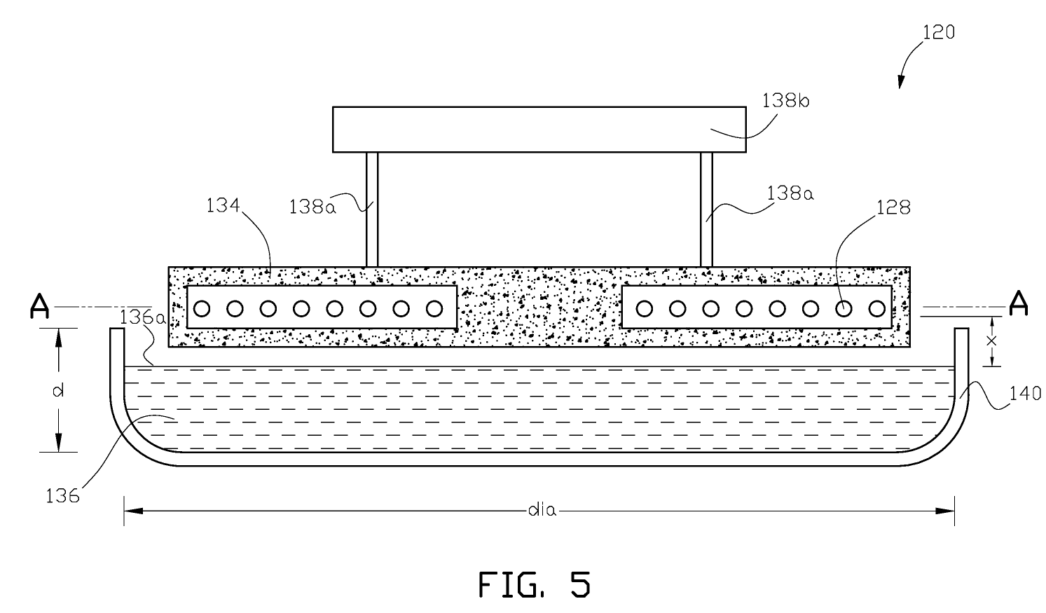

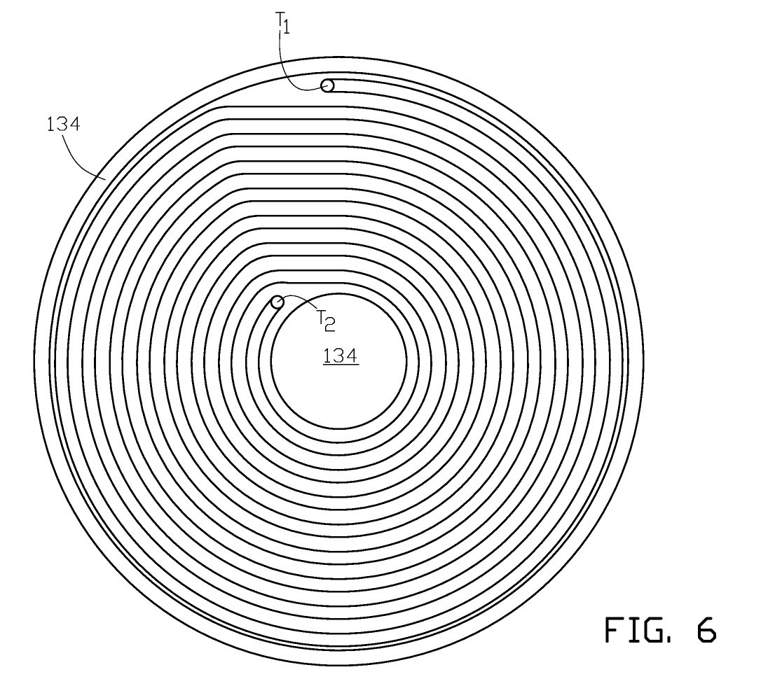

FIG. 5 and FIG. 6 illustrate one non-limiting example of the electric induction heating and melting system 120 of the present invention. System 120 is used for electric induction heating, melting and/or holding at a desired temperature, an electrically conductive material 136 (illustrated in dashed lines), such as a steel alloy composition, in containment vessel 140. The vessel may be generally cylindrical in shape with a large diameter and shallow depth. System 120 includes one or more induction coils 128 at least partially enclosed in refractory 134 so that the one or more induction coils may be brought in close contact with the surface level of material 136.

The refractory embedded inductor comprising the one or more induction coils 128 at least partially embedded in refractory 134, can be coupled to an height adjusting apparatus for providing vertical movement of the refractory embedded inductor. By way of example and not limitation, diagrammatically illustrated support cables 138a and cable hoist 138b may be used to raise or lower the refractory embedded inductor, as the height of material 136 in the vessel rises or drops, to keep the distance, x, between the one or more induction coils and the changing surface level 136a of the material small. For example, initially deposited material in the vessel may be a low (relative to the interior depth, d, of the vessel) level of heel comprising molten steel in which solid or semisolid steel scrap material is added for electric induction melting of the scrap. Addition of scrap to the melt will increase the surface level of material 136 in the containment vessel. At some point in the process, some of the molten material in the containment vessel may be drawn by a suitable method from the containment vessel, which will lower the surface level of material 136 in the vessel.

It is highly desirable to keep the distance, x, between the one or more induction coils 128 and the surface level of material 136 as small as possible in order to maintain high efficiency inductive heating of the material. As stated above, the surface level of the material in the vessel may change, for example, due to removal of some of the molten material from the molten bath; addition of material to alloy the melt in the vessel; or removal of a dross layer from the surface of material 136. System 120 may include a sensor (not shown in the figures), for example a capacitive sensor, to sense the surface level of material 136 in the containment vessel. The sensed level output of the sensor can be inputted to automatic controls that control the height of the one or more induction coils above the surface level as the surface level changes. Alternatively the sensor may comprise a laser distance sensing device that is located in refractory 134 for sensing of the distance, x, as the surface level of the material changes.

In an embodiment wherein the one or more induction coils 128 comprises only one coil (that is, a relatively lightweight refractory and induction coil arrangement), the controls can be linked, for example, to a supporting cable system having support cables 138a and cable hoist 138b. In an embodiment wherein the one or more induction coils 128 comprises more than one coil (that is, a relatively heavy housing), the controls can be linked, for example, to jack screws and supports, or hydraulically operated raising and lowering apparatus with guide rails.

One non-limiting example of dimensions of cylindrical containment vessel 140 for holding the material is on the order of 20 feet in diameter (dia) and 30 inches in depth, d, which is a diameter to depth ratio of 8 to 1. The surface level of material in the vessel 136 from the interior bottom of the vessel can range from slightly more than zero up to slightly less than 30 inches. The refractory embedded inductor can preferably be adjustable to keep the one or more induction coils 128 in a range of about 2 inches from the surface level 136a of melt 136. An approximately 2-inch gap between melt surface level 136 and the one or more induction coils 128 can provide a relatively high inductive heating efficiency of about 60 percent.

A further advantage of the invention is that the magnetic field created by the flow of current through one or more induction coils 128 generates an electromagnetic stirring action in melt 136, in addition to supplying induced heat directly to the melt. This stirring action is advantageous for heating melt 136 more quickly in melting applications, and for mixing when adding alloy material to the melt, such as a steel composition, so that uniform distribution of the alloy material in the melt is obtained.

To improve the stirring action, the one or more induction coils may comprise at least three separate induction coils suitably arranged in a refractory. For heating and melting, identical (in-phase) single phase power can be supplied to each of the at least three induction coils for inductively heating material 136. For stirring of melt 136, each of the at least three induction coils can be supplied with power from a separate phase of a three-phase electrical source having phase currents that are 120 degrees out-of-phase relative to each other. The relative phase shifts generate electromagnetic fluid flow forces in melt 136 that are analogous to forces generated in a three-phase linear motor. While the three-phase operation provides less induced heating, it can provide considerable stirring action. More generally, the three phases need only to be out of phase, and not approximately 120 degrees out-of-phase to induce a stirring action. Further the electrical frequency of the ac power source may be varied to control the degree of stir agitation of the melt.

The circular arrangement of a single induction coil shown in FIG. 6 is one non-limiting example of the one or more induction coils. Coil ends T₁ and T₂ are connected to a suitable ac power source (not shown in the figure) located separate from the refractory embedded inductor. The one or more induction coils 128 may have any other shape in plan view including, but not limited to oval, rectangular or square. The coil shape may be selected based upon a particular application and selected materials. Further one or more induction coil 128 may consist of a single coil with one or more turns, or a multiplicity of separate coils, each with one or more turns.

Further the one or more induction coils 128 may comprise a combination of active and passive coils wherein one or more active coils are each connected to an ac power source located separate from the refractory embedded inductor, and each of the one or more passive coils are connected to a capacitive element located separate from the refractory embedded inductor. When ac current flows through the one or more active coils, a primary magnetic field that couples with the one or more passive coils to induce current flows in the one or more passive coil circuits that generates a secondary magnetic field. Both the primary and secondary magnetic fields result in flux linking with material 136 in the vessel to inductively heat and melt the material.

The present invention may be embodied in other specific forms without departing from the essential attributes thereof and, accordingly, reference should be made to the appended claims, rather than to the foregoing specification, as indicating the scope of the invention. The above examples of the invention have been provided merely for the purpose of explanation, and are in no way to be construed as limiting of the present invention. While the invention has been described with reference to various embodiments, the words used herein are words of description and illustration, rather than words of limitations. Although the invention has been described herein with reference to particular means, materials and embodiments, the invention is not intended to be limited to the particulars disclosed herein; rather, the invention extends to all functionally equivalent structures, methods and uses. Those skilled in the art, having the benefit of the teachings of this specification, may effect numerous modifications thereto, and changes may be made without departing from the scope of the invention in its aspects.

1. Apparatus for heating or melting an electrically conductive material in a shallow open top containment vessel, the apparatus comprising:
at least one induction coil horizontally oriented to the open top of the vessel, the at least one induction coil at least partially embedded in a refractory to form a refractory embedded inductor;
each of the at least one induction coils connected to a suitable alternating current power source; and
a positioning apparatus for adjusting the vertical height of the refractory embedded inductor over the surface level of the electrically conductive material in the vessel.

2. The apparatus of claim 1 wherein the positioning apparatus comprises a plurality of cables connected to the refractory embedded inductor and a cable hoist for raising or lowering the refractory embedded inductor.

3. The apparatus of claim 1 further comprising a sensor to sense the surface level of the electrically conductive material in the vessel.

4. The apparatus of claim 3 wherein the sensor is at least partially embedded in the refractory of the refractory embedded inductor.

5. The apparatus of claim 3 further comprising a processor for outputting a control signal to the positioning apparatus to raise or lower the refractory embedded inductor responsive to the sensed surface level.

6. The apparatus of claim 1 wherein the containment vessel is cylindrical in shape and the ratio of the diameter of the containment vessel to its height is at least approximately 8 to 1.

7. The apparatus of claim 1 wherein the at least one induction coil comprises at least three induction coils with each induction coil connected to at least one ac power source, the at least one ac power source having control circuitry for creating a phase shift between the currents supplied to each of the at least three induction coils.

8. A method of heating and melting an electrically conductive material in an open shallow containment vessel, the method comprising the steps of:
loading the electrically conductive material into the containment vessel;
lowering a horizontally oriented refractory embedded inductor comprising at least one induction coil at least partially embedded in a refractory over the surface of the material in the containment vessel; and
supplying ac current to each of the at least one induction coils to generate a magnetic field that couples with the material to inductively heat the material.

9. The method of claim 8 further comprising the step of sensing the surface level of the material in the vessel and maintaining the refractory embedded inductor at a fixed height over the surface level of the material.

10. The method of claim 9 wherein the at least one induction coil comprises at least three induction coils and phase shifted ac power is supplied to each of the at least three induction coils to electromagnetically stir the material in the containment vessel.
